(19) United States
(12) Patent Application Publication
(10) Pub. No.: US 2006/0231727 A1
(43) Pub. Date: Oct. 19, 2006

(54) Pumpkin support and decorating device

(75) Inventors: Vicky Jo Birkmann, Corona, CA (US); Timothy Andrew Birkmann, Corona, CA (US); Thomas Charles Weiss, Lake Forest, CA (US); Joseph Francis Conte, Lake Forest, CA (US)

Correspondence Address: STETINA BRUNDA GARRED & BRUCKER, 75 ENTERPRISE, SUITE 250, ALISO VIEJO, CA, 92656, US

(73) Assignee: Timothy A. Birkmann dba Sunrise Innovations

(21) Appl. No.: 11/204,245

(22) Filed: Aug. 15, 2005

Related U.S. Application Data
(63) Continuation of application No. 29/227,670, filed on Apr. 14, 2005.

(51) Int. Cl. G09F 17/00; A47G 29/00

(52) U.S. Cl. 248/684; 428/7

(57) ABSTRACT

Provided is a decorative support apparatus for pumpkins mimicking the appearance of Halloween or other holiday character themed hands and legs comprised of two separate leg sections and two separate arm sections. The leg section includes anchors for digging into and securing the pumpkin as well as being configured to support the mass of the pumpkin. The arm section is likewise inserted into the side of the pumpkin via anchors.

### CROSS-REFERENCE TO RELATED APPLICATIONS

The present application is a continuation of Design Patent Application No. 29/227,670 entitled PUMPKIN SUPPORT AND DECORATING DEVICE and filed on Apr. 14, 2005, the entire contents of which are incorporated by reference herein.

### STATEMENT RE: FEDERALLY SPONSORED RESEARCH/DEVELOPMENT

Not Applicable

### BACKGROUND OF THE INVENTION

1. Technical Field

This disclosure relates to a pumpkin stand. More particularly, the present disclosure relates to support structures insertable into a pumpkin.

2. Description of Related Art

Halloween is a celebration well known in Western countries, and is marked by ghosts, monsters, black magic, vampires, zombies, and other spooky or scary elements. Despite the sinister connotations, it is a festive occasion, with young children going “trick-or-treating” wherein children dress up in costumes and trek from house to house asking for candy and other sweets. Children are not the only ones having fun, however, and adults often decorate their houses and yards with elaborate ornaments consistent with the Halloween theme to greet trick-or-treaters with an impressive presentation. Adults find this activity enjoyable because they are basking in the Halloween atmosphere alongside their children, and feel nostalgic about simpler, younger times as a child being concerned not with the struggles and responsibilities of grown-up life, but with merely the maximization of spoils from the night.

One of the most well recognized Halloween decorations is the Jack O'Lantern. Although accounts vary, it is said that there was a clever fellow by the name of Jack who was able to convince the devil not to take his soul upon his death. When Jack died, he was apparently too sinful to enter heaven, but could not enter hell because of his promise with the devil. Jack was thus relegated to roaming the earth looking for a resting place, with only a piece of burning coal as his guide in the dark night. Thereafter, Jack placed the coal in a carved-out turnip, and thus earned the moniker “Jack of the Lantern,” or simply “Jack O'Lantern.”

While in contemporary times, a pumpkin is substituted for the turnip and varying faces are carved into the surface, the decoration continues to light the way for nocturnal travelers, particularly eager trick-or-treaters. The interior of the pumpkin is hollowed out, and a lid is carved out of the top portion to permit insertion and removal of the light source placed within. Openings representative of eyes, a nose, and a mouth are carved out to permit fragments of the light to escape the interior of the pumpkin. The finished Jack O'Lantern is typically placed on windowsills, porches and patios, and front yards.

Considering the universality of the Jack O'Lantern as an autumn and Halloween decoration, a number of devices for holding gourd-related fruit have been disclosed. One such example is U.S. Pat. No. 6,546,654 to Henson discloses a stand for displaying a pumpkin utilizing a tripod structure and an elongate body decoration extending along the tripod structure. While this apparatus prevented fluid pooling at the underside of the pumpkin, the apparatus was too large to be used indoors, and so it was strictly relegated to use in a yard. Additionally, wind or other forces easily tipped over the display, particularly with abnormal surface conditions, despite there being a counterweight on the tripod.

Decorations on pumpkins have previously been applied using toothpicks having attached decorative elements. However, toothpick-based decorations rotated too much within the pumpkin, and were too easily removed.

### BRIEF SUMMARY OF THE INVENTION

In light of the foregoing limitations, the present invention was conceived. Provided is a plurality of support stands and attachments for stabilizing and decoratively enhancing in a consistent fashion the display of a pumpkin.

A plurality of stands is provided for attachment at various intervals, cooperatively supporting the pumpkin across a range of surface configurations. The stands simulate the appearance of feet, and include a metatarsus section and a plurality of toe members. The metatarsus section defines a depression where the pumpkin is received and is further secured by pumpkin attaching anchors protruding from the depression. The toe members include a toenail section where stickers may be attached and which further help stabilize the pumpkin.

A plurality of arm and hand simulating appendages is also provided and each appendage thus includes an arm and a hand section. The hand section is comprised of a plurality of finger members having a fingernail section where stickers may be attached. The arm section includes an appendage securing member which sinks into the surface of the pumpkin and holds it in place.

### BRIEF DESCRIPTION OF THE DRAWINGS

These as well as other features of the present invention will become more apparent upon reference to the drawings wherein:

FIG. 1 is a perspective view of a pumpkin with the present invention attached thereon;

FIG. 2 is a top view of the pumpkin stand and decorative element attached to a pumpkin;

FIG. 3 is a rear view of the pumpkin stand and decorative element attached to the pumpkin;

FIG. 4 is a perspective view of a pumpkin attaching anchor as integrally formed with the pumpkin stand; and

FIG. 5 is a perspective view of an appendage securing member.

### DETAILED DESCRIPTION OF THE INVENTION

The detailed description set forth below in connection with the appended drawings is intended as a description of the presently preferred embodiment of the invention and is not intended to represent the only form in which the present invention may be constructed or utilized. It is to be understood, however, that the same or equivalent functions may be accomplished by different embodiments that are also intended to be encompassed within the spirit and scope of the invention.

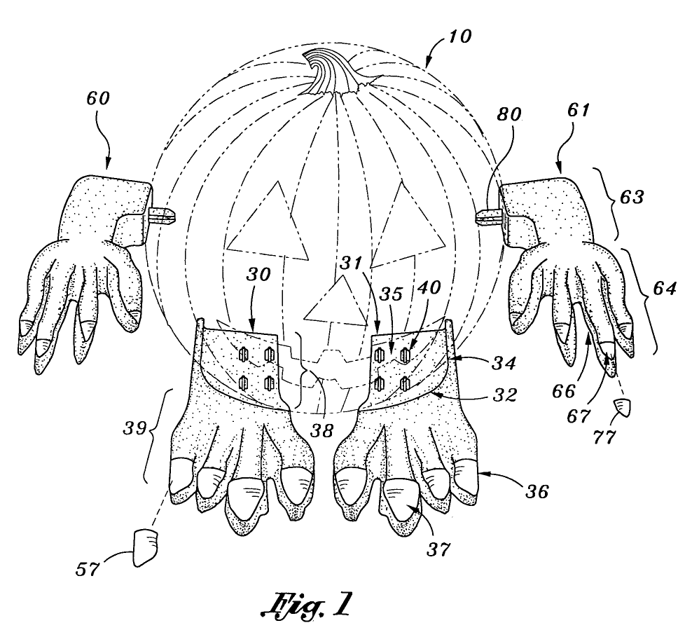

With reference now to FIG. 1, by way of example only and not of limitation, pumpkin 10 in the form of a Jack O'Lantern is shown with respect to the present invention, comprised of right and left support stands 30 and 31, and right and left appendages 60 and 61. The right and left support stands 30, 31 and right and left appendages 60, 61 collectively define a pumpkin attachment apparatus which serves as decoration for the pumpkin 10. Pumpkin 10 need not be a Jack O'Lantern. Any fruit or vegetable having a firm yet pierceable outer shell, typically a member of the gourd family such as squash and melon, carved or otherwise, may be substituted.

The features of the support stands 30, 31 will now be described. Right and left support stands 30 and 31 are configured to position pumpkin 10 in a desirable orientation and to lift the same to prevent moisture buildup and rotting of the pumpkin 10. Any fluids accumulating on the surface of pumpkin 10 will naturally flow to the lowest part, and will eventually drop off the face. As those skilled in the art will appreciate, the separate stands 30, 31 allow for variable interval mounting on pumpkin 10 and therefore accommodate varying shapes and sizes, including deformed pumpkins unable to stand properly alone. This configuration also permits the pumpkin 10 to be placed upright on abnormal locations, such as slanted, rocky, or jagged surfaces. Additionally, right and left support stands 30 and 31 are configured to simulate the appearance of feet such as animal feet, and are accordingly comprised of a metatarsus section 38 and a toe section 39.

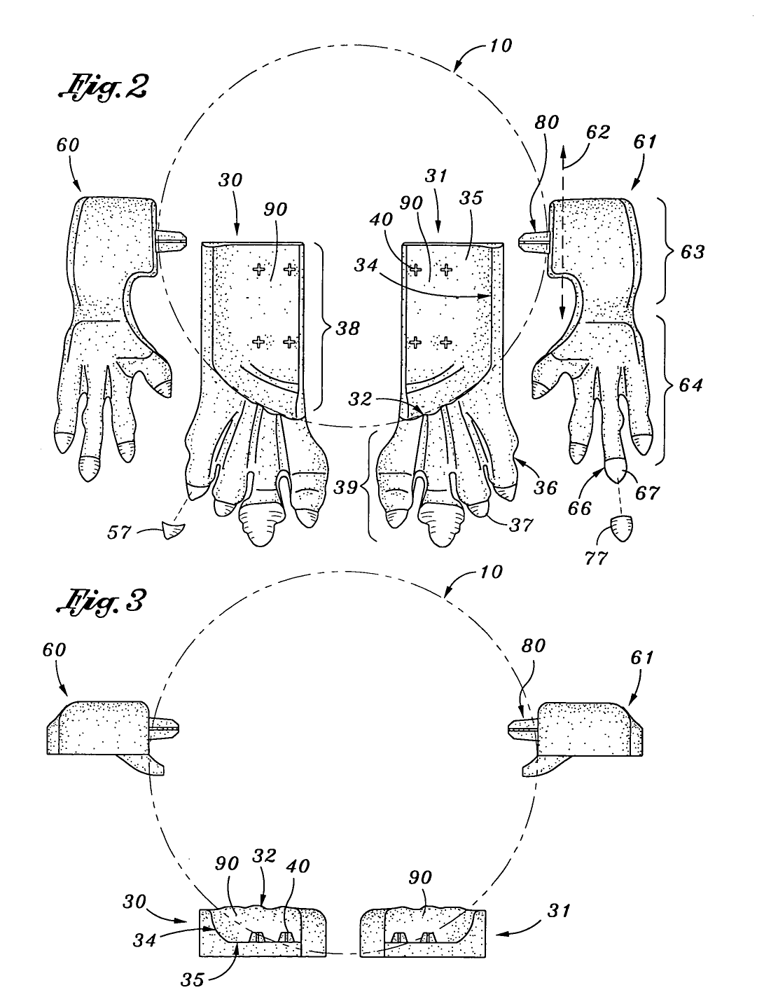

As shown in FIG. 2, metatarsus section 38 is defined by circular periphery wall 32, sidewall 34, and bottom floor 35 which collectively define a depression 90. It should be noted that the circular periphery wall 32 need not be configured in a circular shape but may be configured in a variety of alternative shapes and configurations including elliptical, compound curves, etc. The depression 90 holds pumpkin 10 in place by distributing the gravitational force of pumpkin 10 across the entire surface of metatarsus 38. Furthermore, even distribution is accomplished by the rounded corners between bottom floor 35 and sidewall 34 and between bottom floor 35 and circular periphery wall 32. Additional reference may be had to FIG. 3, showing depression 90 created by circular periphery wall 32, sidewall 34 and bottom floor 35.

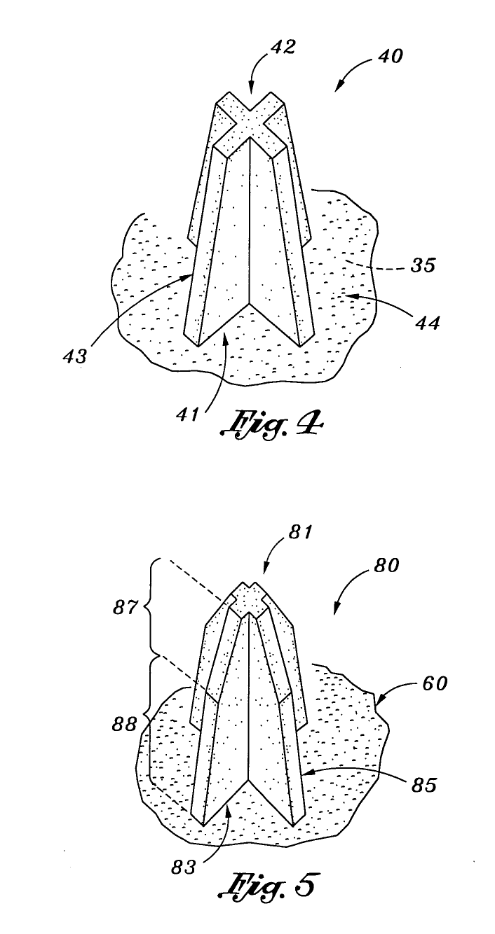

Pumpkin 10 is secured to right and left support stands 30 and 31 via pumpkin attaching anchors 40. With reference now to FIG. 4, pumpkin attaching anchor 40 has blade 43, pumpkin insertion end 42, and metatarsus end 41. When inserted into the pumpkin, its crust encapsulates blade 43. Blade 43 gradually tapers from metatarsus end 41 to pumpkin insertion end 42, and four such blades 43 are arranged in a cross-shaped configuration although the blades may be formed to have any cross-sectional configuration including, but not limited to, rounded, square, rectangular, etc. The cross-shaped configuration retards rotational movement, because any such force applied is met with resistance from blade 43 and the crust of the pumpkin. Furthermore, the taper in blade 43 permits easy insertion and removal, yet safety is maintained by blunting the pumpkin insertion end 42. By way of example only and not of limitation, the individual blades 43 comprising pumpkin attaching anchor 40 are integrally formed with each other and with bottom floor 35. However, the blades 43 may be formed as separate components which may be later attached to the bottom floor 35. Further movement of the pumpkin 10 is prevented by surface bumps 44 on metatarsus 35 which dig slightly into the pumpkin surface and generate resistance.

With reference to FIG. 1 and FIG. 2, toe section 39 includes a plurality of toe members 36. While improving stability, toe members 36 enhance decorative appearance of the pumpkin attachment apparatus. Any variety of foot-like configurations may be utilized and may include a four-toed monster foot as shown, a five-toed human skeleton foot, a witch's boot, or any other feet associated with the thematic characters of the holidays throughout the year. Additionally, toe section 39 includes toenail section 37 for attaching sticker 57 of varying colors thereon and which still further enhances the decorative appearance of the pumpkin attach apparatus. The shapes of the toenail section 37 may be varied across toe members 36 or the toenail section 37 may be of consistent shape throughout. The shape of the sticker 57 may generally correspond to the shape of toenail section 37. The surface of toenail section 37 is smooth so as to enable maximum adhesion of the sticker 57 although the surface of toenail section 37 may be provided in any surface finish including a roughened or bumpy surface finish.

With references to the figures, the features of the appendages 60, 61 will now be described. Right and left appendages 60, 61 are configured to enhance thematic visual appeal and simulate an arm and a hand. Furthermore, the configuration of the right and left appendages 60, 61 allows the decoration to be leaned against a vertical surface and prevents the rolling of pumpkin 10. Each one of the appendages 60, 61 comprises a hand section 64 and an arm section 63. Hand section 64 includes finger members 66 and fingernail section 67. Any number of members shaped in different appearances may be utilized. In a preferred embodiment mimicking the appearance of a mutated monster, four finger members are fashioned. Additional example embodiments include finger members appearing to be human skeleton hands, and a witch's decrepit hands. Like the toe section 57 described above, fingernail section 67 is a shaped to receive sticker 77, and accordingly the surface may be smooth to maximize adhesion of the same.

Right and left appendages 60 and 61 are attached to pumpkin 10 via appendage securing member 80 which extends perpendicularly from the lateral axis 62 of the appendage at arm section 63 as shown in FIG. 2. The single appendage securing member 80 allows right and left appendages 60 and 61 to be inserted in a variety of angles to simulate varying states of being. For example, placement which is substantially parallel to the ground will give the appearance of a zombie walking slowly and steadily toward its intended victim while pointing the fingers toward the air will give the appearance of a rabid ogre rushing to attack. Furthermore, pointing the fingers toward the ground will provide a more restive, peaceable appearance.

Referring now to FIG. 5, appendage securing member 80 is preferably integrally formed with appendage 60 and has a pumpkin insertion end 81 and an appendage attachment end 83. Multiple appendage securing blades 85 are arranged in a cross-shaped configuration and have a first taper section 87 and a second taper section 88. Appendage securing blade 85 is preferably of sufficient size and length to support the weight of appendage securing member 80 and in comparison to the pumpkin attaching member 40 in FIG. 4, is substantially larger. The first taper section 87 reduces the size of the point of insertion while maintaining safety by effectively blunting pumpkin insertion end 81 and eliminating sharp corners. The force required to insert appendage securing member 80 into the pumpkin 10 remains the same as that which was described above for the blades 43 of the pumpkin attaching anchors 40.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A pumpkin attachment apparatus for stabilizing and decoratively enhancing the display of a pumpkin, comprising:
a. a plurality of support stands attachable to the underside of the pumpkin, each one of the support stands having a themed decorative appearance simulating a foot with a metatarsus section for cooperatively securing the support stand to the pumpkin and a plurality of toe members extending from the metatarsus section;
b. one or more pumpkin attaching anchors protruding from the metatarsus section; and
c. a plurality of appendages having a themed decorative appearance similar to that of the support stand simulating an arm and a hand with a plurality of finger members, wherein each one of the appendages is attached to the pumpkin with an appendage securing member.

2. The apparatus as set forth in claim 1, wherein the metatarsus section defines a depression formed in the support stand.

3. The apparatus as set forth in claim 1, wherein the surface of the metatarsus section has a bumpy surface finish to facilitate positioning of the pumpkin and enhance visual appeal.

4. The apparatus as set forth in claim 1, wherein the appendage extends along a lateral axis and the appendage securing member protrudes substantially perpendicularly from the lateral axis.

5. The apparatus as set forth in claim 1, wherein the pumpkin attachment apparatus is constructed of weather resistant plastic.

6. The apparatus as set forth in claim 1, wherein the pumpkin attaching anchors are a cross shaped extrusion having a metatarsus end and a pumpkin insertion end, wherein the pumpkin insertion end is tapered.

7. The apparatus as set forth in claim 1, wherein the appendage securing member is a cross shaped extrusion having a pumpkin insertion end and an appendage attachment end, wherein the pumpkin insertion end is tapered.

8. The apparatus as set forth in claim 1, wherein the pumpkin attaching anchors are integrally formed with the support stands.

9. The apparatus as set forth in claim 1, wherein the appendage securing members are integrally formed with the appendages.

10. The apparatus as set forth in claim 1, wherein the toe members have a toenail section for affixing a toenail simulation sticker.

11. The apparatus as set forth in claim 10, wherein the toenail section is a smooth surface capable of maintaining adhesive contact with the toenail simulation sticker.

12. The apparatus as set forth in claim 1, wherein the finger members have a fingernail section for affixing a fingernail simulation sticker.

13. The apparatus as set forth in claim 12, wherein the fingernail section is a smooth surface capable of maintaining adhesive contact with the fingernail simulation sticker.
